(19) United States
(12) Patent Application Publication
(10) Pub. No.: US 2024/0386499 A1
(43) Pub. Date: Nov. 21, 2024

(54) INVESTMENT TRUST PRICE PREDICTION DEVICE AND PREDICTION MODEL

(71) Applicant: NTT DOCOMO, INC., Tokyo (JP)

(72) Inventors: Kazuki KINJOU, Chiyoda-ku (JP); Masayuki TERADA, Chiyoda-ku (JP); Hiroto AKATSUKA, Chiyoda-ku (JP); Motoko SUZUKI, Chiyoda-ku (JP); Takako KOMINATO, Chiyoda-ku (JP)

(73) Assignee: NTT DOCOMO, INC., Tokyo (JP)

(21) Appl. No.: 18/691,141

(22) PCT Filed: Aug. 22, 2022
(86) PCT No.: PCT/JP2022/031591

§ 371 Date: Mar. 12, 2024

(30) Foreign Application Priority Data
Sep. 30, 2021 (JP) 2021-160672

(51) Int. Cl. G06Q 40/06; G06Q 50/16

(52) U.S. Cl. CPC G06Q 40/06; G06Q 50/16

(57) ABSTRACT

The value of the real estate investment trust is predicted. A REIT price prediction device 1 includes: a storage unit 10 that stores a prediction model for predicting a future REIT price, the prediction model being generated by learning based on training data comprising sets of input data, which comprises population distribution data regarding the population distribution around each of a plurality of real estate properties in which a REIT (Real Estate Investment Trust) invests, and a REIT price indicating the value of the REIT; an acquisition unit 11 that acquires the input data; and an output unit 13 that outputs the future REIT price obtained by applying the input data acquired by the acquisition unit 11 to the prediction model stored in the storage unit 10.

### TECHNICAL FIELD

One aspect of the present disclosure relates to an investment trust value prediction device and a prediction model for predicting an investment trust value indicating the value of a real estate investment trust.

### BACKGROUND ART

Patent Literature 1 below discloses a real-time evaluation system that obtains changes in the actual evaluation of target real estate in real time from REIT (Real Estate Investment Trust) securities prices.

### CITATION LIST

### Patent Literature

Patent Literature 1: Japanese Unexamined Patent Publication No. 2004-295534

### SUMMARY OF INVENTION

### Technical Problem

However, in the real-time evaluation system described above, the REIT securities prices are merely used, but are not used to predict the REIT securities prices, for example. Therefore, it is desired to predict the value of a real estate investment trust.

### Solution to Problem

An investment trust value prediction device according to one aspect of the present disclosurecomprises: a storage unit that stores a prediction model for predicting a future investment trust value, the prediction model being generated by learning based on training data comprising sets of input data, which comprises population distribution data regarding a population distribution around each of a plurality of real estate properties in which a real estate investment trust invests, and an investment trust value indicating a value of the real estate investment trust; an acquisition unit that acquires the input data; and an output unit that outputs the future investment trust value obtained by applying the input data acquired by the acquisition unit to the prediction model stored in the storage unit.

According to this aspect, it is possible to output the future investment trust value by using the prediction model. That is, it is possible to predict the value of the real estate investment trust.

### Advantageous Effects of Invention

According to one aspect of the present disclosure, it is possible to predict the value of the real estate investment trust.

### BRIEF DESCRIPTION OF DRAWINGS

FIG. 1 A schematic diagram showing a usage image of a REIT price prediction device according to an embodiment.

FIG. 2 A diagram showing an example of the system configuration of a REIT price prediction system including the REIT price prediction device according to the embodiment.

FIG. 3 A diagram showing an example of a table of population distribution data.

FIG. 4 A diagram showing an example of a table of REIT price data.

FIG. 5 A diagram showing an example of a table of REIT-owned real estate data.

FIG. 6 A diagram showing an example of a table of urban development plan data.

FIG. 7 A diagram showing an example of a table of store opening plan data.

FIG. 8 A diagram showing an example of a table of investment market trend indicator data (Nikkei average stock price data).

FIG. 9 A diagram showing an example of a table of investment market trend indicator data (Dow average stock price data).

FIG. 10 A diagram showing an example of a table of investment market trend indicator data (government bond yield data).

FIG. 11 A diagram showing an example of a table of route price data.

FIG. 12 A diagram showing an example of the functional configuration of the REIT price prediction device according to the embodiment.

FIG. 13 A flowchart showing an example of storage processing performed by the REIT price prediction system.

FIG. 14 A diagram showing an example of training data.

FIG. 15 A diagram showing another example of training data.

FIG. 16 A diagram showing an example of the learning interval.

FIG. 17 A diagram showing an example of prediction model replacement.

FIG. 18 A flowchart showing an example of output processing performed by the REIT price prediction system.

FIG. 19 A flowchart showing an example of REIT price prediction processing performed by the REIT price prediction device according to the embodiment.

FIG. 20 A diagram showing an example of the hardware configuration of a computer used in the REIT price prediction device according to the embodiment.

### DESCRIPTION OF EMBODIMENTS

Hereinafter, embodiments of the present disclosure will be described in detail with reference to the diagrams. In addition, in the description of the diagrams, the same elements are denoted by the same reference numerals, and repeated description thereof will be omitted. In addition, the embodiments of the present disclosure in the following description are specific examples of the present invention, and the present invention is not limited to these embodiments unless there is a statement that specifically limits the present invention.

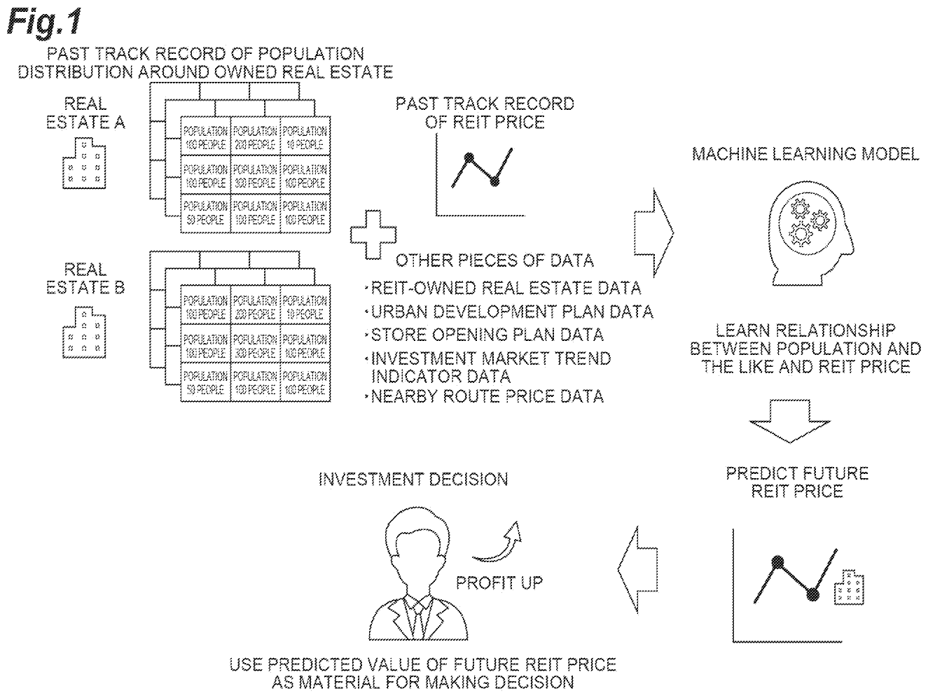

FIG. 1 is a schematic diagram showing a usage image of a REIT price prediction device 1 (investment trust value prediction device) according to an embodiment. The REIT price prediction device 1 is a server device that predicts an investment trust value indicating the value of a real estate investment trust. In the present embodiment, REITs are used as real estate investment trusts and REIT prices are used as investment trust values, but the present invention is not limited to these. In the present embodiment, the term “REIT” may be replaced with “real estate investment trust” as appropriate, and the term “REIT price” may be replaced with “investment trust value” as appropriate.

A REIT is a financial product that collects funds from many investors, invests in a plurality of properties (office buildings, commercial facilities, condominiums, and the like), and distributes the resulting rental income, real estate sales profits, and the like to the investors as capital. Regarding REITs, investors are issued investment securities (equivalent to stock certificates), assigned a securities code in the same manner as stocks, and can buy and sell these on stock exchanges. In the present embodiment, for the convenience of explanation, processing related to a specific (one already determined) REIT rather than a certain REIT will be described. For example, by appropriately using a REIT ID, which is REIT identification information, during processing, it is possible to extend the processing related to any REIT.

The REIT price is a price as the value of the REIT, specifically, the price of the REIT securities (securities price).

Although detailed explanations will be given later, as shown in FIG. 1, the REIT price prediction device 1 performs machine learning on (at least one of) the past track record of the population distribution around owned real estate (a plurality of real estate properties) in which the REIT invests, the past track record of REIT prices, and other pieces of data such as REIT-owned real estate data, urban development plan data, store opening plan data, investment market trend indicator data, and nearby route price data. Through machine learning, the relationship between population and the like and the REIT prices is learned, and a prediction model (machine learning model) is generated. The REIT price prediction device 1 outputs predicted values of future REIT prices by using the prediction model (predicts future REIT prices). Customers such as investors can aim to improve profits by making investment decisions using the predicted values of future REIT prices output from the REIT price prediction device 1 as materials for making decisions.

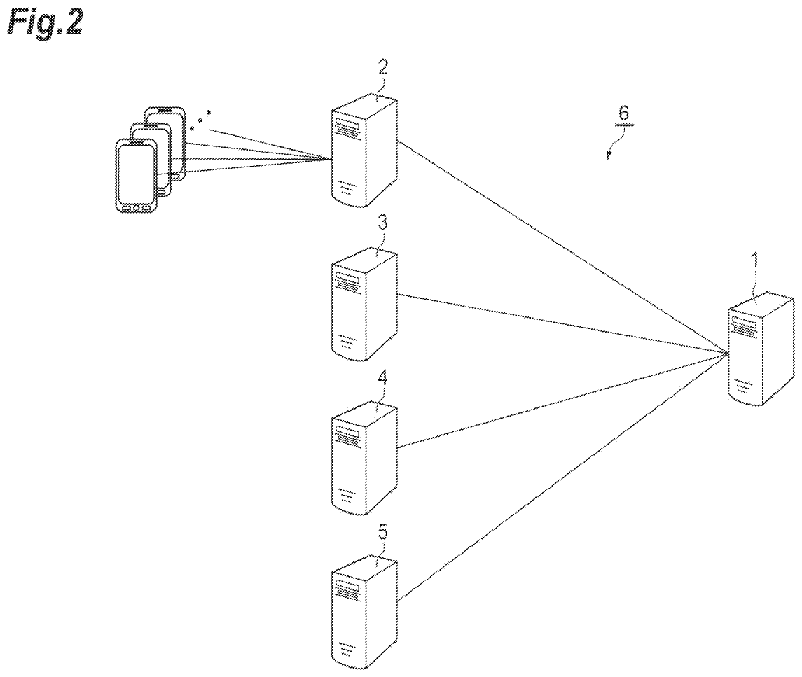

FIG. 2 is a diagram showing an example of the system configuration of a REIT price prediction system 6 (investment trust value prediction system) including the REIT price prediction device 1 according to the embodiment. As shown in FIG. 2, the REIT price prediction system 6 includes the REIT price prediction device 1, a population distribution data acquisition device 2, a REIT trading device 3, a REIT management device 4, and an external data acquisition device 5. The REIT price prediction device 1, the population distribution data acquisition device 2, the REIT trading device 3, the REIT management device 4, and the external data acquisition device 5 are communicably connected to each other through a network, such as the Internet, so that information can be transmitted and received therebetween.

The population distribution data acquisition device 2 is a server device that acquires population distribution data regarding the population distribution around (near, close to, in the vicinity of, within a predetermined distance) each of a plurality of real estate properties in which the REIT invests and transmits the population distribution data to the REIT price prediction device 1. The information regarding the REIT or the plurality of real estate properties may be stored in the population distribution data acquisition device 2 in advance, or may be transmitted and acquired in advance from the REIT price prediction device 1. Without being limited to the population distribution data acquisition device 2, the information regarding the REITs or a plurality of real estate properties in which the REIT invests that are targeted in the present embodiment may be stored in advance in various devices, or may be transmitted and acquired in advance from the REIT price prediction device 1 or the like.

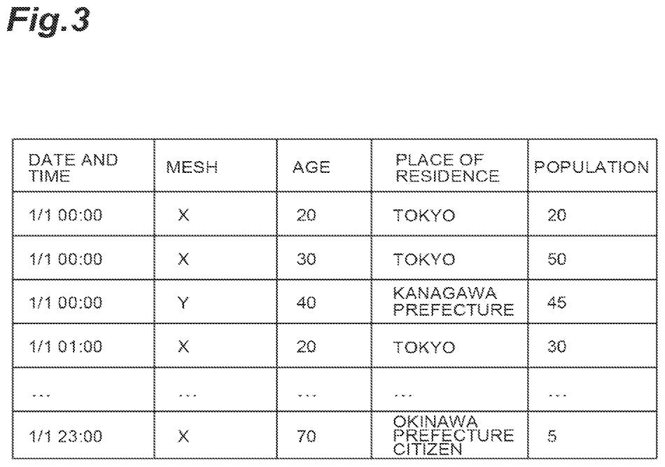

FIG. 3 is a diagram showing an example of a table of population distribution data. As shown in FIG. 3, in the population distribution data, date and time, a mesh indicating the position or range, a persons age, a person's place of residence, and a population that is the number of people of the age and the place of residence who are present in the mesh at the date and time are associated with each other. The population distribution data shown in FIG. 3 indicates, for example, population distribution data around real estate A, which is one of the plurality of real estate properties in which the REIT invests. In this case, (the location of) the real estate A is included within the ranges of a mesh X and a mesh Y shown in FIG. 3.

The population distribution data acquisition device 2 may acquire population distribution data based on terminal information collected from a mobile terminal, which is a mobile terminal capable of performing mobile communication and carried by each person and which can measure its own location using a GPS (Global Positioning System), and information regarding the REIT or a plurality of real estate properties in which the REIT invests. When collecting the terminal information, for example, known techniques such as Mobile Spatial Statistics (registered trademark) provided by NTT DOCOMO, INC. are used. The population distribution data acquisition device 2 may acquire population distribution data in real time and transmit the population distribution data to the REIT price prediction device 1.

The REIT trading device 3 is a server device that acquires REIT price data including REIT prices and transmits the REIT price data to the REIT price prediction device 1. The REIT trading device 3 collects information regarding REITs (including REIT price data) and performs trading related to the REITs by transmitting and receiving data to and from the server device of the stock exchange. The REIT trading device 3 may acquire REIT price data in real time and transmit the REIT price data to the REIT price prediction device 1.

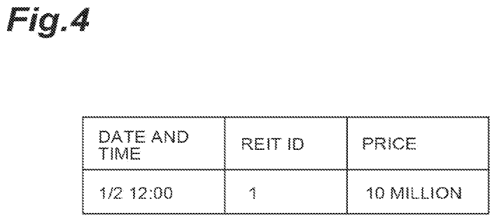

FIG. 4 is a diagram showing an example of a table of REIT price data. FIG. 4, in the REIT price data, a date and time, a REIT ID that is the identification information of the REIT, and a price that is the REIT price of the REIT identified by the REIT ID at the date and time are associated with each other.

The REIT management device 4 is a server device that acquires REIT-owned real estate data, which is data regarding a plurality of real estate properties in which the REIT invests, and transmits the REIT-owned real estate data to the REIT price prediction device 1. The REIT management device 4 manages the REIT-owned real estate data. For example, the REIT management device 4 may acquire REIT-owned real estate data input from the administrator of the REIT management device 4, or may acquire the REIT-owned real estate data from another device through a network. The REIT management device 4 may acquire the REIT-owned real estate data every six months and transmit the REIT-owned real estate data to the REIT price prediction device 1.

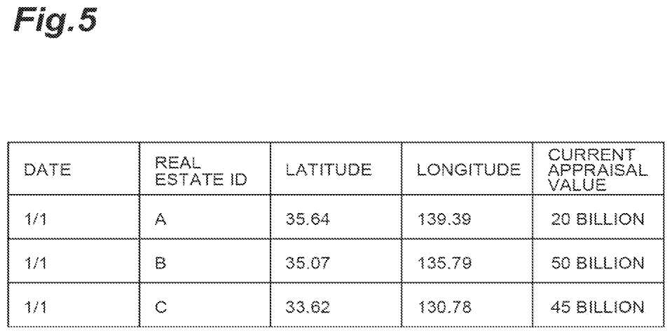

FIG. 5 is a diagram showing an example of a table of REIT-owned real estate data. As shown in FIG. 5, in the REIT-owned real estate data, a date, a real estate ID that is the identification information of the real estate, a latitude that is the location of the real estate identified by the real estate ID, a longitude that is the location of the real estate identified by the real estate ID, and a current appraisal value that is the appraised value of the real estate identified by the real estate ID on the date are associated with each other.

The external data acquisition device 5 is a server device that acquires external data, which is data acquired from an external device or the like, and transmits the external data to the REIT price prediction device 1. The external data includes urban development plan data, store opening plan data, investment market trend indicator data, and nearby route price data. For example, the external data acquisition device 5 may acquire external data from other various devices through a network. The external data acquisition device 5 may acquire external data in real time and transmit the external data to the REIT price prediction device 1.

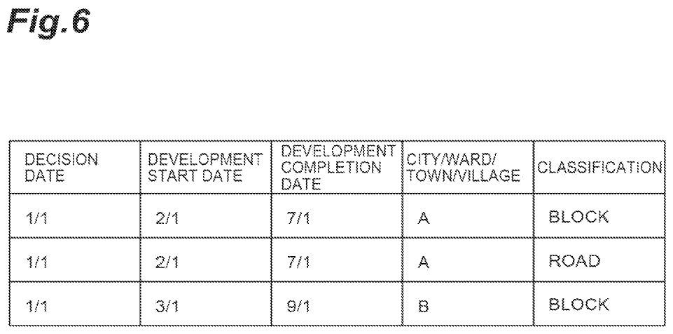

FIG. 6 is a diagram showing an example of a table of urban development plan data. As shown in FIG. 6, in the REIT-owned real estate data, a decision date that is the date on which the urban development plan was decided, a development start date that is the date on which the urban development started, a development completion date that is a date on which the urban development was completed, city/ward/town/village that is the target of the urban development, and the distinction classification of the urban development are associated with each other. The urban development plan data shown in FIG. 6 indicates, for example, urban development plan data for city/ward/town/village including a plurality of real estate properties in which the REIT invests. In this case, the plurality of real estate properties are included in A city/ward/town/village and B city/ward/town/village ward shown in FIG. 6.

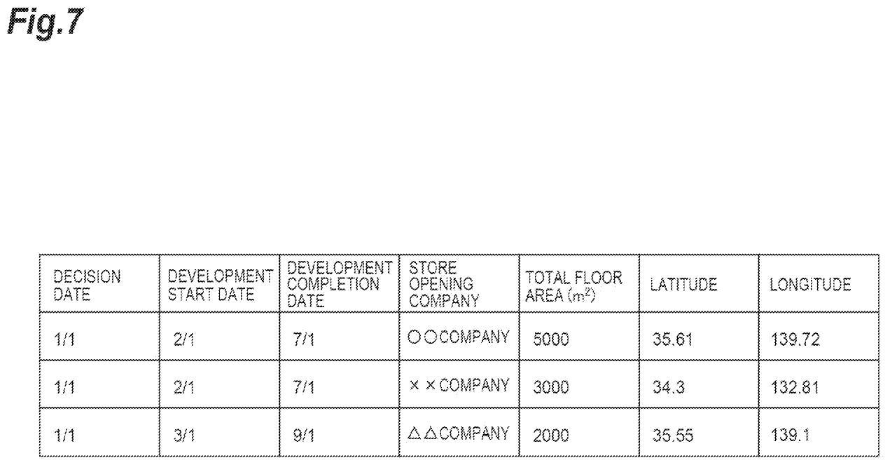

FIG. 7 is a diagram showing an example of a table of store opening plan data. As shown in FIG. 7, in the store opening plan data, a decision date that is the date on which the store opening plan was decided, a development start date that is the date on which the opening of the store started, a development completion date that is the date on which the opening of the store was completed, a store opening company that is a company that opened the store, the total floor area of the store to be opened, a latitude where the store is located, and a longitude where the store is located are associated with each other. The store opening plan data shown in FIG. 7 indicates, for example, store opening plan data around each of a plurality of real estate properties in which the REIT invests. In this case, the stores having the latitudes and longitudes shown in FIG. 7 are stores located around the plurality of real estate properties.

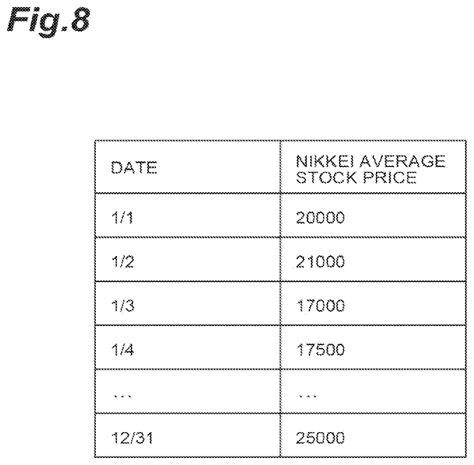

FIG. 8 is a diagram showing an example of a table of Nikkei average stock price data in investment market trend indicator data. As shown in FIG. 8, in the Nikkei average stock price data, a date and time and the Nikkei average stock price at the date and time are associated with each other.

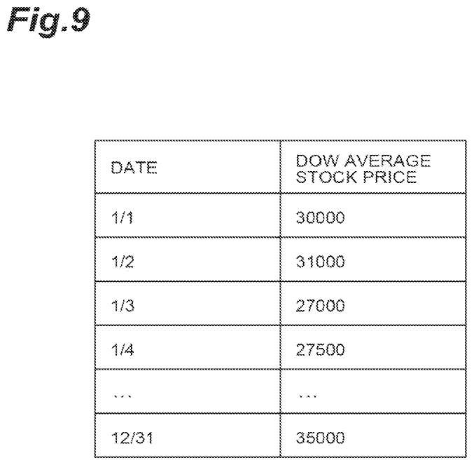

FIG. 9 is a diagram showing an example of a table of Dow average stock price data in investment market trend indicator data. As shown in FIG. 9, in the Dow average stock price data, a date and time and the Dow average stock price at the date and time are associated with each other.

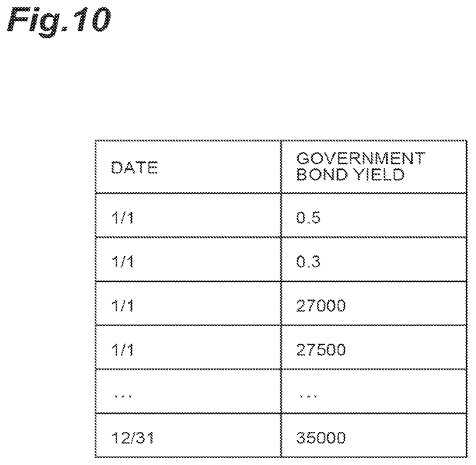

FIG. 10 is a diagram showing an example of a table of government bond yield data in investment market trend indicator data. As shown in FIG. 10, in the government bond yield data, a date and time and a government bond yield at the date and time are associated with each other.

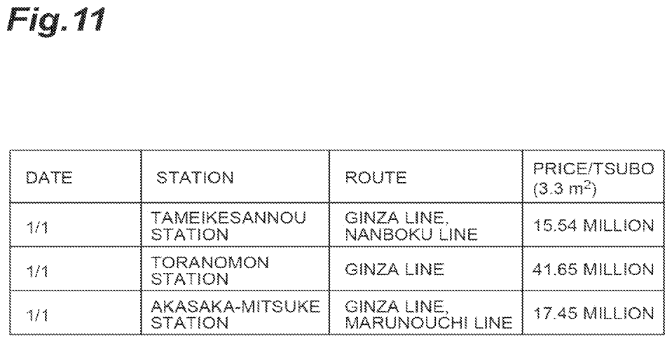

FIG. 11 is a diagram showing an example of a table of route price data. As shown in FIG. 11, in the route price data, a date, a station, a route passing through the station, and price/tsubo that is the price per tsubo (3.3 m²) as a route price around the station are associated with each other. The route price data shown in FIG. 11 indicates, for example, route price data around each of a plurality of real estate properties in which the REIT invests. In this case, the stations shown in FIG. 11 are stations located around the plurality of real estate properties.

The above explanation has been given on the assumption that the data necessary for the processing of the REIT price prediction device 1 is prepared in advance on each device side of the population distribution data acquisition device 2, the REIT trading device 3, the REIT management device 4, and the external data acquisition device 5, but the present invention is not limited to this. For example, the data necessary for the processing of the REIT price prediction device 1 may be prepared in such a manner that each of the population distribution data acquisition device 2, the REIT trading device 3, the REIT management device 4, and the external data acquisition device 5 transmits nationwide raw data, rather than data related to a specific real estate, to the REIT price prediction device 1 and data related to a plurality of real estate properties in which the REIT invests is extracted from the raw data on the REIT price prediction device 1 side.

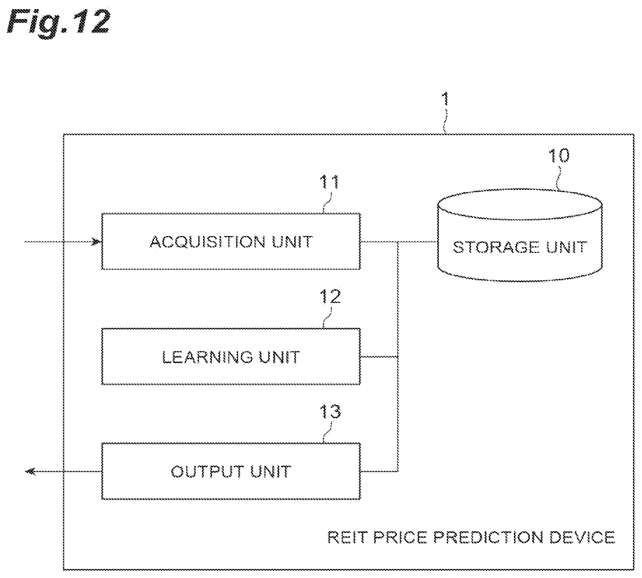

FIG. 12 is a diagram showing an example of the functional configuration of the REIT price prediction device 1 according to the embodiment. As shown in FIG. 12, the REIT price prediction device 1 includes a storage unit 10 (storage unit), an acquisition unit 11 (acquisition unit), a learning unit 12 (learning unit), and an output unit 13 (output unit).

Each functional block of the REIT price prediction device 1 is assumed to function within the REIT price prediction device 1, but the present invention is not limited to this. For example, some of the functional blocks of the REIT price prediction device 1 may function within a computer device, which is a computer device different from the REIT price prediction device 1 and is connected to the REIT price prediction device 1 through a network, while appropriately transmitting and receiving information to and from the REIT price prediction device 1. In addition, some of the functional blocks of the REIT price prediction device 1 may be omitted, a plurality of functional blocks may be integrated into one functional block, or one functional block may be separated into a plurality of functional blocks.

Hereinafter, each function of the REIT price prediction device 1 shown in FIG. 12 will be described.

The storage unit 10 stores any information used for calculations in the REIT price prediction device 1, calculation results of the REIT price prediction device 1, and the like. The information stored in the storage unit 10 may be referenced by each function of the REIT price prediction device 1 as appropriate.

The storage unit 10 stores a prediction model described below. The storage unit 10 may store the prediction model generated by the learning unit 12.

The acquisition unit 11 acquires population distribution data from the population distribution data acquisition device 2 and stores the population distribution data in the storage unit 10. The acquisition unit 11 acquires REIT price data from the REIT trading device 3 and causes the storage unit 10 to store the REIT price data. The acquisition unit 11 acquires REIT-owned real estate data from the REIT management device 4 and causes the storage unit 10 to store the REIT-owned real estate data. The acquisition unit 11 acquires external data (urban development plan data, store opening plan data, investment market trend indicator data, nearby route price data, and the like) from the external data acquisition device 5 and causes the storage unit 10 to store the external data.

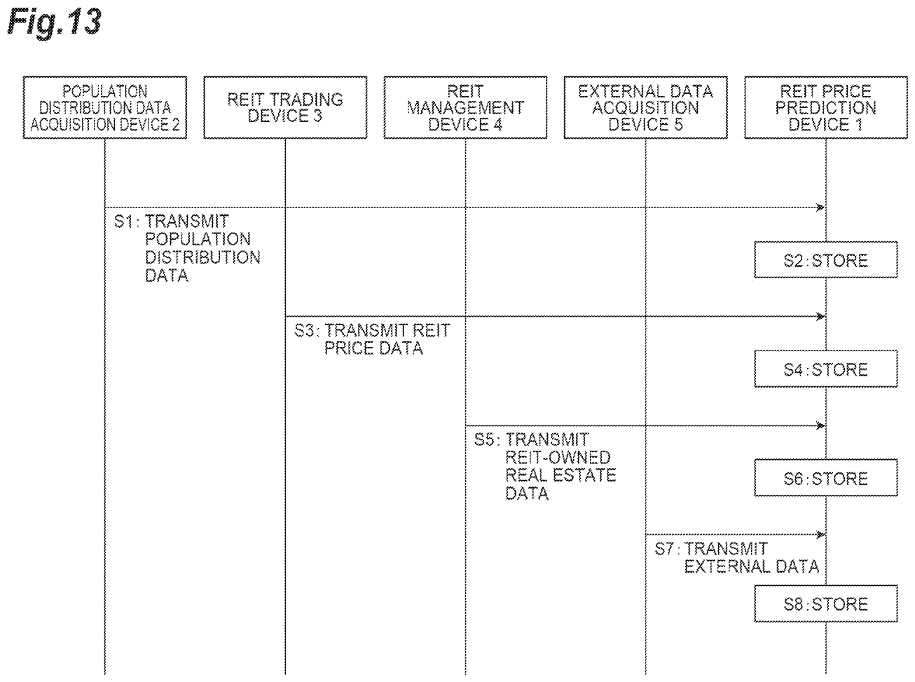

FIG. 13 is a flowchart showing an example of storage processing performed by the REIT price prediction system 6. In FIG. 13, first, the population distribution data acquisition device 2 transmits population distribution data to the REIT price prediction device 1 (step S1). Then, the REIT price prediction device 1 causes the storage unit 10 to store the population distribution data transmitted in S1 (step S2). Then, the REIT trading device 3 transmits REIT price data to the REIT price prediction device 1 (step S3). Then, the REIT price prediction device 1 causes the storage unit 10 to store the REIT price data transmitted in S3 (step S4). Then, the REIT management device 4 transmits REIT-owned real estate data to the REIT price prediction device 1 (step S5). Then, the REIT price prediction device 1 causes the storage unit 10 to store the REIT-owned real estate data transmitted in S5 (step S6). Then, the external data acquisition device 5 transmits external data to the REIT price prediction device 1 (step S7). Then, the REIT price prediction device 1 causes the storage unit 10 to store the external data transmitted in S7 (step S8).

In addition, in FIGS. 13, S1, S3, S5, and S7 may be in any order and may be executed multiple times, and each step of S1, S3, S5, and S7 may be repeatedly executed periodically. S2 may be executed at any time after S1. S4 may be executed at any time after S3. S6 may be executed at any time after S5. S8 may be executed at any time after S7.

The acquisition unit 11 acquires input data. The acquisition unit 11 may acquire input data at one point in time.

The input data includes population distribution data regarding the population distribution around each of a plurality of real estate properties in which the REIT invests. The input data may further include REIT prices. The input data may further include at least one of the appraised value (current appraisal value) of each of the plurality of real estate properties, data regarding the urban development plan (urban development plan data) around each of the plurality of real estate properties, data regarding the store opening plan (store opening plan data) around each of the plurality of real estate properties, data regarding the investment market trend (investment market trend indicator data), and data regarding route prices (route price data) around each of the plurality of real estate properties.

The learning unit 12 generates a prediction model (trained model) by performing learning. The prediction model Predicts future REIT prices.

The prediction model is a trained model used by the REIT price prediction device 1 including the acquisition unit 11 that acquires population distribution data regarding the population distribution around each of a plurality of real estate properties in which the REIT invests and the output unit 13 that outputs the REIT price indicating the value of the REIT, and is configured by a neural network in which weighting coefficients are learned based on population distribution data and REIT prices. The output unit 13 outputs the future REIT price obtained by applying the population distribution data acquired by the acquisition unit 11 to the prediction model.

The prediction model is a combination of a computer program and parameters. In addition, the prediction model is a combination of the structure of a neural network and a parameter (weighting coefficient) that is the strength of the connection between neurons in the neural network. In addition, the prediction model is a combination of instructions for a computer to obtain a single result (execute predetermined processing), that is, a computer program that causes the computer to function.

The learning unit 12 may generate a prediction model by performing learning based on training data including sets of input data and REIT prices. The sets may include input data at a certain point in time and REIT prices after a predetermined period from the certain point in time.

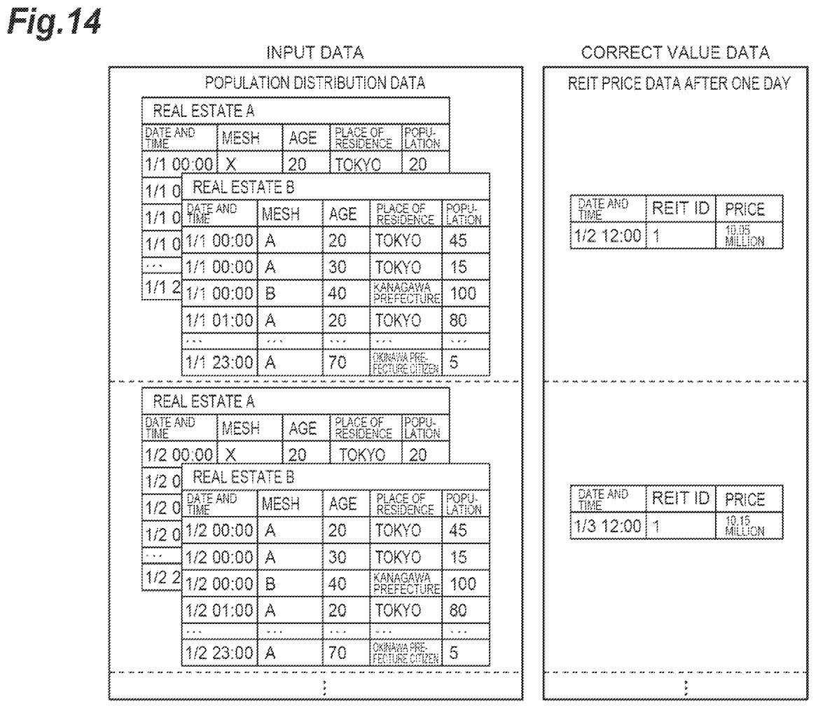

For example, the learning unit 12 generates a prediction model by performing learning based on training data including sets of (input data including) population distribution data (regarding the population distribution around each of a plurality of real estate properties in which the REIT invests) at a certain point in time and REIT prices after a predetermined period from the certain point in time. FIG. 14 is a diagram showing an example of training data. The training data shown in FIG. 14 includes sets of population distribution data (input data) (regarding the population distribution around each of a plurality of real estate properties in which the REIT invests) for a certain day and REIT price data (correct value data) (including REIT prices) for the next day (after a predetermined period) of the day. In the training data shown in FIG. 14, two sets of a set of input data for January 1st and correct value data for January 2nd (the day after January 1st) and a set of input data for January 2nd and correct value data for January 3rd (the day after January 2nd) are shown (in practice, there may be three or more sets).

By performing learning based on the training data shown in FIG. 14, the learning unit 12 learns, for example, a relationship with respect to REIT prices after one day from the population by age and place of residence in a mesh around the REIT-owned real estate for a certain day. By performing learning based on the training data shown in FIG. 14, the learning unit 12 generates a prediction model that outputs REIT prices (or REIT price data) for the next day of the target day of the applied population distribution data. That is, the generated prediction model Predicts future REIT prices.

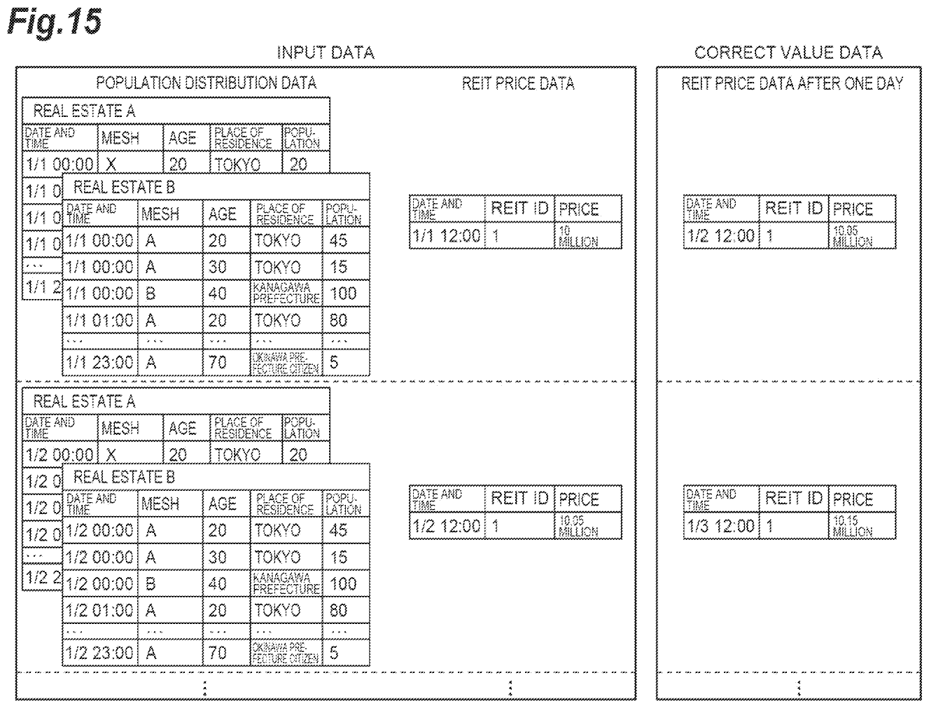

For example, the learning unit 12 generates a prediction model by performing learning based on training data including sets of (input data including) population distribution data (regarding the population distribution around each of a plurality of real estate properties in which the REIT invests) at a certain point in time and REIT prices at the certain point in time and REIT prices after a predetermined period from the certain point in time. FIG. 15 is a diagram showing another example of training data. The training data shown in FIG. 15 includes sets of population distribution data (regarding the population distribution around each of a plurality of real estate properties in which the REIT invests) for a certain day and REIT price data (input data) (including REIT prices) for the day and REIT price data (correct value data) (including REIT prices) for the next day (after a predetermined period) of the day. In the training data shown in FIG. 15, two sets of a set of input data for January 1st and correct value data for January 2nd (the day after January 1st) and a set of input data for January 2nd and correct value data for January 3rd (the day after January 2nd) are shown (in practice, there may be three or more sets).

By performing learning based on the training data shown in FIG. 15, the learning unit 12 learns, for example, a relationship with respect to REIT prices after one day from the population by age and place of residence in a mesh around the REIT-owned real estate for a certain day and REIT prices on the day. By performing learning based on the training data shown in FIG. 15, the learning unit 12 generates a prediction model that outputs the REIT price (or REIT price data) on the next day of the target day of the applied population distribution data and REIT price data. That is, the generated prediction model Predicts future REIT prices.

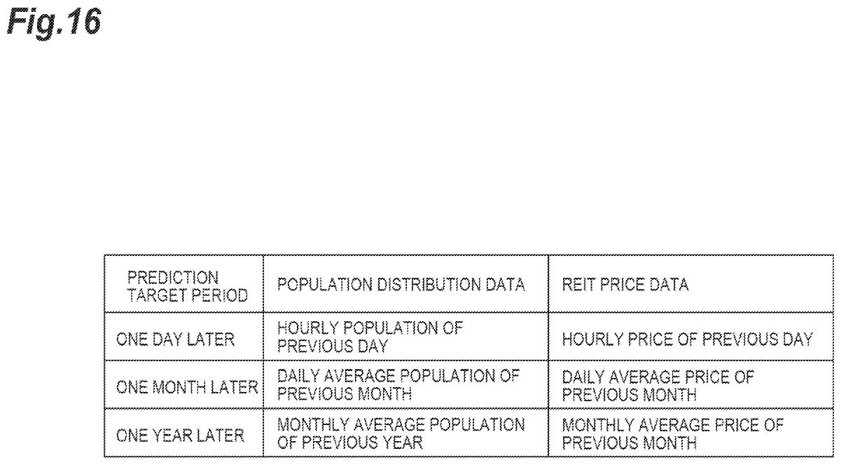

The time interval (learning interval) between pieces of training data may be set according to the predetermined period (prediction target period) described above. FIG. 16 is a diagram showing an example of the learning interval. As shown in FIG. 16, if the prediction target period is one day later, the population distribution data that is (input data of) training data may be set to population distribution data regarding the hourly population of the previous day, and the REIT price data that is (input data of) training data may be set to REIT price data regarding the hourly REIT price of the previous day. In addition, in this case, the previous day's hourly data may be acquired and used every day as the investment market trend indicator data, the REIT-owned real estate data may be acquired and used every six months (because the data is published every six months), and the urban development plan data and the store opening plan data may be acquired and used on a monthly basis (because the data is not updated frequently).

Similarly, if the prediction target period is one month later, the population distribution data that is (input data of) training data may be set to population distribution data regarding the daily average population of the previous month, and the REIT price data that is (input data of) training data may be set to REIT price data regarding the daily average REIT price of the previous month. Similarly, if the prediction target period is one year later, the population distribution data that is (input data of) training data may be set to population distribution data regarding the monthly average population of the previous year, and the REIT price data that is (input data of) training data may be set to REIT price data regarding the monthly average REIT price of the previous year.

When there is a change in the real estate in which the REIT invests, the learning unit 12 may generate a new prediction model based on the changed real estate and replace the existing prediction model stored in the storage unit 10 with the new prediction model. The learning unit 12 may replace the existing prediction model with the new prediction model at a timing when the prediction accuracy of the new prediction model becomes superior to the prediction accuracy of the existing prediction model.

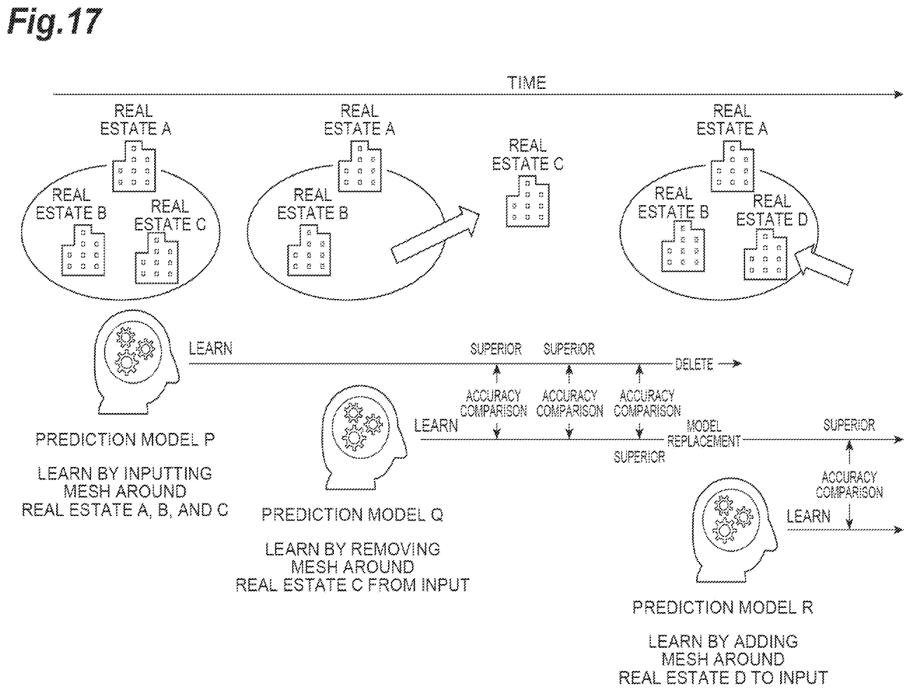

FIG. 17 is a diagram showing an example of prediction model replacement. In FIG. 17, time flows from left to right. It is assumed that at the first point in time (left side in FIG. 17), the REIT invests in real estate A, B, and C. At the first point in time, the learning unit 12 generates a prediction model P by learning based on training data based on real estate A, B, and C, and causes the storage unit 10 to store the prediction model P. For a while after the first point in time, the prediction model P is used in the REIT price prediction device 1.

It is assumed that at the second point in time (middle in FIG. 17) when time has passed from the first point in time, the REIT no longer invests in real estate C and accordingly, the REIT's investment destinations have been changed to real estate A and B. At the second point in time, the learning unit 12 generates a prediction model Q by learning based on the training data based on real estate A and B. At this time, the learning unit 12 compares the prediction accuracy of the prediction model Q, which is a new prediction model, with the prediction accuracy of the prediction model P, which is an existing prediction model. For example, the prediction accuracy may be calculated based on a comparison between a predicted value and a subsequent actual value, or may be calculated by using other known techniques. If the prediction accuracy of the prediction model P is superior, the prediction model P continues to be used in the REIT price prediction device 1, and thereafter the learning unit 12 periodically compares the prediction accuracy of the prediction model P with the prediction accuracy of the prediction model Q. Then, when the prediction accuracy of the prediction model Q becomes superior, the learning unit 12 replaces the prediction model P stored in the storage unit 10 with the prediction model Q. For a while after the replacement, the prediction model Q is used in the REIT price prediction device 1.

It is assumed that at the third point in time (right in FIG. 17) when time has passed from the second point in time, real estate D is added to the REIT's investment destinations and the REIT's investment destinations have been changed to real estate A, B, and D. At the third point in time, the learning unit 12 generates a prediction model R by learning based on the training data based on real estate A, B, and D. At this time, the learning unit 12 compares the prediction accuracy of the prediction model R, which is a new prediction model, with the prediction accuracy of the prediction model Q, which is an existing prediction model. The subsequent processing is the same as the processing after the second point in time described above.

The output unit 13 outputs a future REIT price obtained by applying the input data acquired by the acquisition unit 11 to the prediction model stored in the storage unit 10. The output unit 13 may output a REIT price after a predetermined period from one point in time, which is obtained by applying the input data at the one point in time acquired by the acquisition unit 11 to the prediction model.

For example, the output unit 13 acquires a REIT price one day after (for example, September 2nd) the current point in time by applying population distribution data (regarding the population distribution around each of a plurality of real estate properties in which the REIT invests) at the current point in time (for example, September 1st) acquired by the acquisition unit 11 to the model generated by learning based on the training data shown in FIG. 14, and outputs the acquired REIT price.

For example, the output unit 13 acquires a REIT price one day after (for example, September 2nd) the current point in time by applying population distribution data (regarding the population distribution around each of a plurality of real estate properties in which the REIT invests) at the current point in time (for example, September 1st) acquired by the acquisition unit 11 and the REIT price data at the current point in time to the model generated by learning based on the training data shown in FIG. 15, and outputs the acquired REIT price.

The output from the output unit 13 may be displayed on a display, may be output to other functional blocks of the REIT price prediction device 1, or may be transmitted to other devices through a network.

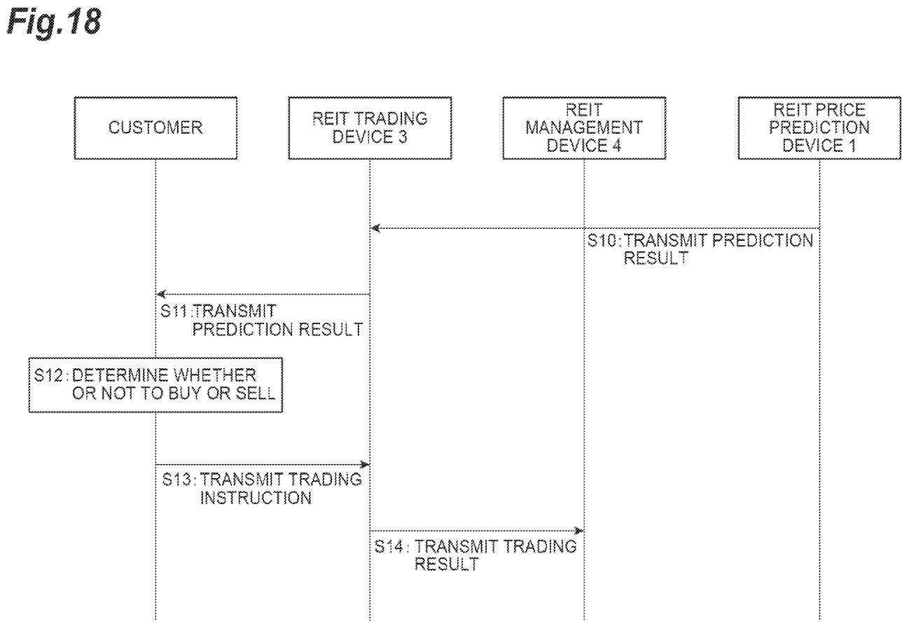

FIG. 18 is a flowchart showing an example of the output processing performed by the REIT price prediction system 6. First, the (output unit 13 of) REIT price prediction device 1 transmits a REIT price, which is a prediction result, to the REIT trading device 3 (step S10). In addition, instead of the REIT price, data including a REIT ID that is the identification information of the REIT, a future date and time, and a REIT price (predicted price) at the date and time may be transmitted. Then, the REIT trading device 3 transmits the REIT price received in S10 to (smartphone or the like of) the customer (step S11). In addition, instead of the REIT price, data including a REIT ID that is the identification information of the REIT, a current REIT price, a predicted value of the future REIT price, and a prediction target time may be transmitted.

Then, the customer determines whether or not to buy or sell the REIT with reference to the REIT price received in S11 (step S12). Then, the customer transmits a trading instruction based on the determination result of S12 to the REIT trading device 3 (step S13). In addition, instead of the trading instruction, data including a customer ID that is the identification information of the customer, a REIT ID that is the identification information of the REIT, a trading price, and a trading flag indicating trading may be transmitted. Then, the REIT trading device 3 performs trading based on the trading instruction received in S13, and transmits the trading result to the REIT management device 4 (step S14). The REIT management device 4 manages the REIT based on the trading result received in S14.

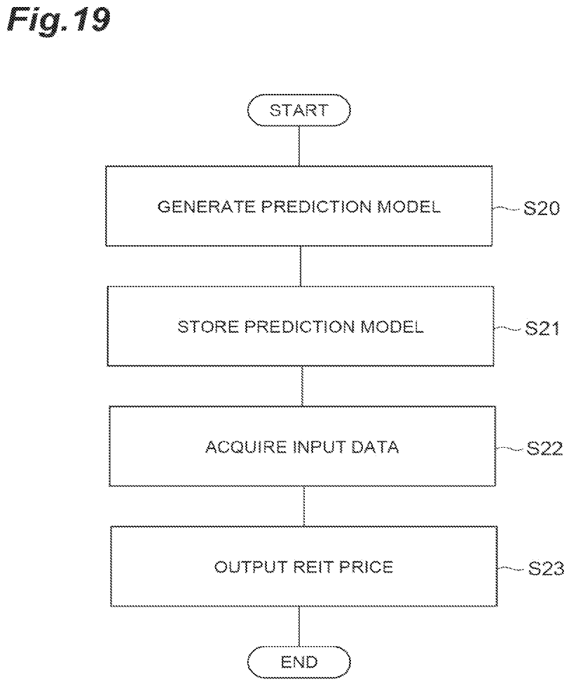

Next, an example of REIT price prediction processing performed by the REIT price prediction device 1 will be described with reference to FIG. 19. FIG. 19 is a flowchart showing an example of the REIT price prediction processing performed by the REIT price prediction device 1 according to the embodiment. First, the learning unit 12 generates a prediction model (step S20). Then, the storage unit 10 stores the prediction model generated in S20 (step S21). Then, the acquisition unit 11 acquires input data (step S22). Then, the output unit 13 outputs a REIT price obtained by applying the input data acquired in S22 to the prediction model stored in S21 (step S23). In addition, S22 may be executed at any timing before S23.

Next, the effects of the REIT price prediction device 1 according to the embodiment will be described.

According to the REIT price prediction device 1, the storage unit 10 stores a prediction model for predicting the future REIT. The prediction model is generated by learning based on training data comprising sets of input data, which comprises population distribution data regarding the population distribution around each of a plurality of real estate properties in which the REIT invests, and a REIT price indicating the value of the REIT. The acquisition unit 11 acquires the input data. The output unit 13 outputs the future REIT price obtained by applying the input data acquired by the acquisition unit 11 to the prediction model stored in the storage unit 10. With this configuration, it is possible to output the future REIT price by using the prediction model. That is, it is possible to predict the value of the real estate investment trust.

In addition, according to the REIT price prediction device 1, the sets may comprise the input data at a certain point in time and the REIT price after a predetermined period from the certain point in time. The acquisition unit 11 may acquire the input data at one point in time. The output unit 13 may output the REIT price after the predetermined period from the one point in time, the REIT price being obtained by applying the input data at the one point in time acquired by the acquisition unit 11 to the prediction model. With this configuration, it is possible to output the REIT price after a predetermined period from one point in time by using the prediction model. That is, it is possible to predict the value of the real estate investment trust.

In addition, according to the REIT price prediction device 1, the input data may further comprise the REIT price. With this configuration, the content of the training data is expanded. As a result, it is possible to use a prediction model capable of more accurately predicting the REIT price. That is, it is possible to predict a more accurate REIT price.

In addition, according to the REIT price prediction device 1, the input data may further comprise at least one of the appraised value of each of the plurality of real estate properties, data regarding the urban development plan around each of the plurality of real estate properties, data regarding the store opening plan around each of the plurality of real estate properties, data regarding the investment market trend, and data regarding route prices around each of the plurality of real estate properties. With this configuration, the content of the training data is expanded. As a result, it is possible to use a prediction model capable of more accurately predicting the REIT price. That is, it is possible to predict a more accurate REIT price.

In addition, the REIT price prediction device 1 may further comprise the learning unit 12 that generates a prediction model by performing learning, and the storage unit 10 stores the prediction model generated by the learning unit 12. With this configuration, it is possible to generate a prediction model and use the generated prediction model.

In addition, according to the REIT price prediction device 1, when there is a change in real estate in which the REIT invests, the learning unit 12 may generate a new prediction model based on the changed real estate and replace the existing prediction model stored in the storage unit 10 with a new prediction model. With this configuration, when there is a change in real estate in which the REIT invests, it is possible to use a new prediction model based on the changed real estate.

In addition, according to the REIT price prediction device 1, the learning unit 12 may replace the existing prediction model with the new prediction model at a timing when the prediction accuracy of the new prediction model becomes superior to the prediction accuracy of the existing prediction model. With this configuration, when there is a change in real estate in which the REIT invests, it is possible to continue using a prediction model with better prediction accuracy. Generally, REITs can acquire or leave real estate at the discretion of the management company. Therefore, when such an event occurs, the REIT price prediction device 1 newly generates a prediction model and performs learning and compares errors in prediction results as appropriate. The REIT price prediction device 1 performs model replacement at the timing when the accuracy of the branched prediction model becomes superior to the current model based on the comparison result.

In addition, the prediction model is a prediction model that is a trained model used by the REIT price prediction device 1 comprising the acquisition unit 11 that acquires population distribution data regarding the population distribution around each of a plurality of real estate properties in which the REIT invests and the output unit 13 that outputs a REIT price indicating the value of the REIT price. The prediction model is configured by a neural network in which weighting coefficients are learned based on the population distribution data and the REIT price. The output unit 13 outputs a future REIT price obtained by applying the population distribution data acquired by the acquisition unit 11 to the prediction model. With this configuration, it is possible to output the future REIT price by using the prediction model. That is, it is possible to predict the value of the real estate investment trust.

Here, conventional problems will be described. In REIT investment, predicting future security values is important in protecting owned assets. However, no uniform method has been established to predict the security values with high accuracy. Therefore, there has been a problem that it is difficult to take future value changes into consideration when making investment decisions.

According to the REIT price prediction device 1, it is possible to predict future REIT security values (REIT prices) by using past population distribution data around REIT-owned real estate by gender, age, and place of residence. Then, by using the prediction results as materials for investment decisions, it is possible to maximize returns for investors (customers).

The learning unit 12 of the REIT price prediction device 1 may generate a future REIT price prediction model by using accumulated past data (population distribution data around each REIT-owned real estate, each real estate appraisal value, external data, and REIT price data). The output unit 13 of the REIT price prediction device 1 may calculate a future REIT price by inputting the same current data (population distribution data around each REIT-owned real estate, each real estate appraisal value, external data, and REIT price data) to the prediction model.

In addition, the block diagrams used in the description of the above embodiment show blocks in functional units. These functional blocks (configuration units) are realized by any combination of at least one of hardware and software. In addition, a method of realizing each functional block is not particularly limited. That is, each functional block may be realized using one physically or logically coupled device, or may be realized by connecting two or more physically or logically separated devices directly or indirectly (for example, using a wired or wireless connection) and using the plurality of devices. Each functional block may be realized by combining the above-described one device or the above-described plurality of devices with software.

Functions include determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but are not limited thereto. For example, a functional block (configuration unit) that makes the transmission work is called a transmitting unit or a transmitter. In any case, as described above, the implementation method is not particularly limited.

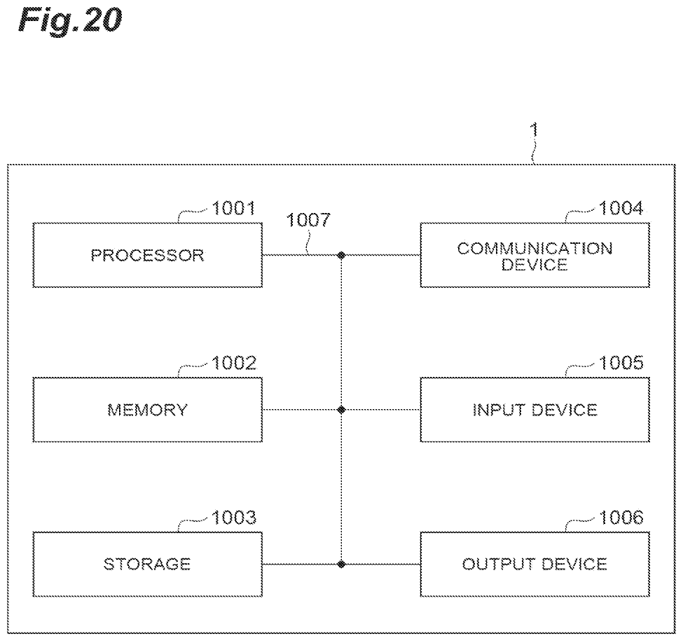

For example, the REIT price prediction device 1 and the like according to an embodiment of the present disclosure may function as a computer that performs processing of the REIT price prediction method of the present disclosure. FIG. 20 is a diagram showing an example of the hardware configuration of the REIT price prediction device 1 according to an embodiment of the present disclosure. The REIT price prediction device 1 described above may be physically configured as a computer device including a processor 1001, a memory 1002, a storage 1003, a communication device 1004, an input device 1005, an output device 1006, a bus 1007, and the like.

In addition, in the following description, the term “device” can be read as a circuit, a device, a unit, and the like. The hardware configuration of the REIT price prediction device 1 may include one or more devices for each device shown in the diagram, or may not include some devices.

Each function in the REIT price prediction device 1 is realized by reading predetermined software (program) onto hardware, such as the processor 1001 and the memory 1002, so that the processor 1001 performs an operation and controlling communication by the communication device 1004 or controlling at least one of reading and writing of data in the memory 1002 and the storage 1003.

The processor 1001 controls the entire computer by operating an operating system, for example. The processor 1001 may be configured by a central processing unit (CPU) including an interface with a peripheral device, a control device, an operation device, a register, and the like. For example, the above-described acquisition unit 11, learning unit 12, output unit 13, and the like may be realized by the processor 1001.

In addition, the processor 1001 reads a program (program code), a software module, data, and the like into the memory 1002 from at least one of the storage 1003 and the communication device 1004, and executes various kinds of processing according to these. As the program, a program causing a computer to execute at least a part of the operation described in the above embodiment is used. For example, the acquisition unit 11, the learning unit 12, and the output unit 13 may be realized by a control program stored in the memory 1002 and operating in the processor 1001, or may be realized similarly for other functional blocks. Although it has been described that the various kinds of processes described above are performed by one processor 1001, the various kinds of processes described above may be performed simultaneously or sequentially by two or more processors 1001. The processor 1001 may be realized by one or more chips. In addition, the program may be transmitted from a network through a telecommunication line.

The memory 1002 is a computer-readable recording medium, and may be configured by at least one of, for example, a ROM (Read Only Memory), an EPROM (Erasable Programmable ROM), an EEPROM (Electrically Erasable Programmable ROM), and a RAM (Random Access Memory). The memory 1002 may be called a register, a cache, a main memory (main storage device), and the like. The memory 1002 can store a program (program code), a software module, and the like that can be executed to implement the radio communication method according to an embodiment of the present disclosure.

The storage 1003 is a computer-readable recording medium, and may be configured by at least one of, for example, an optical disk such as a CD-ROM (Compact Disc ROM), a hard disk drive, a flexible disk, and a magneto-optical disk (for example, a compact disk, a digital versatile disk, and a Blu-ray (registered trademark) disk), a smart card, a flash memory (for example, a card, a stick, and a key drive), a floppy (registered trademark) disk, and a magnetic strip. The storage 1003 may be called an auxiliary storage device. The storage medium described above may be, for example, a database including at least one of the memory 1002 and the storage 1003, a server, or other appropriate media.

The communication device 1004 is hardware (transmitting and receiving device) for performing communication between computers through at least one of a wired network and a radio network, and is also referred to as, for example, a network device, a network controller, a network card, and a communication module. The communication device 1004 may include, for example, a high-frequency switch, a duplexer, a filter, a frequency synthesizer, and the like in order to realize at least one of frequency division duplex (FDD) and time division duplex (TDD), for example. For example, the above-described acquisition unit 11, learning unit 12, output unit 13, and the like may be realized by the communication device 1004.

The input device 1005 is an input device (for example, a keyboard, a mouse, a microphone, a switch, a button, and a sensor) for receiving an input from the outside. The output device 1006 is an output device (for example, a display, a speaker, and an LED lamp) that performs output to the outside. In addition, the input device 1005 and the output device 1006 may be integrated (for example, a touch panel).

In addition, respective devices, such as the processor 1001 and the memory 1002, are connected to each other by the bus 1007 for communicating information. The bus 1007 may be configured using a single bus, or may be configured using a different bus for each device.

In addition, the REIT price prediction device 1 may include hardware, such as a microprocessor, a digital signal processor (DSP), an ASIC (Application Specific Integrated Circuit), a PLD (Programmable Logic Device), and an FPGA (Field Programmable Gate Array), and some or all of the functional blocks may be realized by the hardware. For example, the processor 1001 may be realized by using at least one of these hardware components.

The notification of information is not limited to the aspects/embodiments described in the present disclosure, and may be performed using other methods.

Each aspect/embodiment described in the present disclosure may be applied to at least one of systems, which use LTE (Long Term Evolution), LTE-A (LTE-Advanced), SUPER 3G, IMT-Advanced, 4G (4th generation mobile communication system), 5G (5th generation mobile communication system), FRA (Future Radio Access), and NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and next-generation systems extended based on these. In addition, a plurality of systems may be combined (for example, a combination of 5G and at least one of LTE and LTE-A) to be applied.

In the processing procedure, sequence, flowchart, and the like in each aspect/embodiment described in this disclosure, the order may be changed as long as there is no contradiction. For example, for the methods described in the present disclosure, elements of various steps are presented using an exemplary order. However, the present invention is not limited to the specific order presented.

The information and the like that are input and output may be stored in a specific place (for example, a memory) or may be managed using a management table. The information and the like that are input and output can be overwritten, updated, or added. The information and the like that are output may be deleted. The information and the like that are input may be transmitted to other devices.

The determination may be performed based on a value (0 or 1) expressed by 1 bit, may be performed based on the Boolean value (Boolean: true or false), or may be performed by numerical value comparison (for example, comparison with a predetermined value).

Each aspect/embodiment described in the present disclosure may be used alone, may be used in combination, or may be switched and used according to execution. In addition, the notification of predetermined information (for example, notification of “X”) is not limited to being explicitly performed, and may be performed implicitly (for example, without the notification of the predetermined information).

While the present disclosure has been described in detail, it is apparent to those skilled in the art that the present disclosure is not limited to the embodiments described in the present disclosure. The present disclosure can be realized as modified and changed aspects without departing from the spirit and scope of the present disclosure defined by the description of the claims. Therefore, the description of the present disclosure is intended for illustrative purposes, and has no restrictive meaning to the present disclosure.

Software, regardless of whether this is called software, firmware, middleware, microcode, a hardware description language, or any other name, should be interpreted broadly to mean instructions, instruction sets, codes, code segments, program codes, programs, subprograms, software modules, applications, software applications, software packages, routines, subroutines, objects, executable files, execution threads, procedures, functions, and the like.

In addition, software, instructions, information, and the like may be transmitted and received through a transmission medium. For example, when software is transmitted from a website, a server, or other remote sources using at least one of the wired technology (coaxial cable, optical fiber cable, twisted pair, digital subscriber line (DSL), and the like) and the wireless technology (infrared, microwave, and the like), at least one of the wired technology and the wireless technology is included within the definition of the transmission medium.

The information, signals, and the like described in the present disclosure may be expressed using any of a variety of different technologies. For example, data, instructions, commands, information, signals, bits, symbols, and chips that can be referred to throughout the above description may be represented by voltage, current, electromagnetic waves, magnetic field or magnetic particles, light field or photon, or any combination thereof.

In addition, the terms described in this disclosure and the terms necessary for understanding this disclosure may be replaced with terms having the same or similar meaning.

The terms “system” and “network” used in the present disclosure are used interchangeably.

In addition, the information, parameters, and the like described in the present disclosure may be expressed using an absolute value, may be expressed using a relative value from a predetermined value, or may be expressed using another corresponding information.

The names used for the parameters described above are not limiting names in any way. In addition, equations and the like using these parameters may be different from those explicitly disclosed in the present disclosure.

The term “determining” used in the present disclosure may involve a wide variety of operations. For example, “determining” can include considering judging, calculating, computing, processing, deriving, investigating, looking up (search, inquiry) (for example, looking up in a table, database, or another data structure), and ascertaining as “determining”. In addition, “determining” can include considering receiving (for example, receiving information), transmitting (for example, transmitting information), input, output, and accessing (for example, accessing data in a memory) as “determining”. In addition, “determining” can include considering resolving, selecting, choosing, establishing, comparing, and the like as “determining”. That is, “determining” can include considering any operation as “determining”. In addition, “determining” may be read as “assuming”, “expecting”, “considering”, and the like.

The terms “connected” and “coupled” or variations thereof mean any direct or indirect connection or coupling between two or more elements, and can include a case where one or more intermediate elements are present between two elements “connected” or “coupled” to each other. The coupling or connection between elements may be physical, logical, or a combination thereof. For example, “connection” may be read as “access”. When used in the present disclosure, two elements can be considered to be “connected” or “coupled” to each other using at least one of one or more wires, cables, and printed electrical connections and using some non-limiting and non-inclusive examples, such as electromagnetic energy having wavelengths in a radio frequency domain, a microwave domain, and a light (both visible and invisible) domain.

The description “based on” used in the present disclosure does not mean “based only on” unless otherwise specified. In other words, the description “based on” means both “based only on” and “based at least on”.

Any reference to elements using designations such as “first” and “second” used in the present disclosure does not generally limit the quantity or order of the elements. These designations can be used in the present disclosure as a convenient method for distinguishing between two or more elements. Therefore, references to first and second elements do not mean that only two elements can be adopted or that the first element should precede the second element in any way.

“Means” in the configuration of each device described above may be replaced with “unit”, “circuit”, “device”, and the like.

When “include”, “including”, and variations thereof are used in the present disclosure, these terms are intended to be inclusive similarly to the term “comprising”. In addition, the term “or” used in the present disclosure is intended not to be an exclusive-OR.

In the present disclosure, when articles, for example, a, an, and the in English, are added by translation, the present disclosure may include that nouns subsequent to these articles are plural.

In the present disclosure, the expression “A and B are different” may mean “A and B are different from each other”. In addition, the expression may mean that “A and B each are different from C”. Terms such as “separated”, “coupled” may be interpreted similarly to “different”.

### REFERENCE SIGNS LIST

1: REIT price prediction device, 2: population distribution data acquisition device, 3: REIT trading device, 4: REIT management device, 5: external data acquisition device, 6: REIT price prediction system, 10: storage unit, 11: acquisition unit, 12: learning unit, 13: output unit, 1001: processor, 1002: memory, 1003: storage, 1004: communication device, 1005: input device, 1006: output device, 1007: bus.

1. An investment trust value prediction device, comprising processing circuitry configured to:
store a prediction model for predicting a future investment trust value, the prediction model being generated by learning based on training data comprising sets of input data, which comprises population distribution data regarding a population distribution around each of a plurality of real estate properties in which a real estate investment trust invests, and an investment trust value indicating a value of the real estate investment trust;
acquire the input data; and
output the future investment trust value obtained by applying the acquired input data to the stored prediction model.

2. The investment trust value prediction device according to claim 1,
wherein the sets comprise the input data at a certain point in time and the investment trust value after a predetermined period from the certain point in time,
the processing circuitry is configured to acquire the input data at one point in time, and
the processing circuitry is configured to output the investment trust value after the predetermined period from the one point in time, the investment trust value being obtained by applying the acquired input data at the one point in time to the prediction model.

3. The investment trust value prediction device according to claim 1,
wherein the input data further comprises the investment trust value.

4. The investment trust value prediction device according to claim 1,
wherein the input data further comprises at least one of an appraised value of each of the plurality of real estate properties, data regarding an urban development plan around each of the plurality of real estate properties, data regarding a store opening plan around each of the plurality of real estate properties, data regarding an investment market trend, and data regarding route prices around each of the plurality of real estate properties.

5. The investment trust value prediction device according to claim 1:
wherein the processing circuitry is further configured to generate the prediction model by performing the learning,
wherein the processing circuitry is configured to store the generated prediction model.

6. The investment trust value prediction device according to claim 5,
wherein, when there is a change in real estate in which the real estate investment trust invests, the processing circuitry is configured to generate the prediction model, which is new and based on the changed real estate, and replaces the stored existing prediction model with the new prediction model.

7. The investment trust value prediction device according to claim 6,
wherein the processing circuitry is configured to replace the existing prediction model with the new prediction model at a timing when a prediction accuracy of the new prediction model becomes superior to a prediction accuracy of the existing prediction model.

8. A non-transitory computer readable medium that stores prediction model that is a trained model used by an investment trust value prediction device comprising processing circuitry configured to acquire population distribution data regarding a population distribution around each of a plurality of real estate properties in which a real estate investment trust invests and to output an investment trust value indicating a value of the real estate investment trust,
wherein the prediction model is configured by a neural network in which weighting coefficients are learned based on the population distribution data and the investment trust value, and the processing circuitry configured to output a future investment trust value obtained by applying the acquired population distribution data to the prediction model.

9. The investment trust value prediction device according to claim 2,
wherein the input data further comprises the investment trust value.
